(19) United States
(12) Patent Application Publication
(10) Pub. No.: US 2016/0303544 A1
(43) Pub. Date: Oct. 20, 2016

(54) METHOD OF MAKING A METALLIC COMPOSITE AND USE THEREOF

(71) Applicant: PORTLAND STATE UNIVERSITY, Portland, OR (US)

(72) Inventors: Jun Jiao, Portland, OR (US); Wen Qian, San Diego, CA (US)

(73) Assignee: Portland State University, Portland, OR (US)

(21) Appl. No.: 15/033,870

(22) PCT Filed: Nov. 3, 2014
(86) PCT No.: PCT/US2014/063747

§ 371 Date: May 2, 2016

Related U.S. Application Data
(60) Provisional application No. 61/899,626, filed on Nov. 4, 2013.

(51) Int. Cl. B01J 23/52; C02F 1/72; B01J 37/03; B01J 21/18; B01J 35/00

(52) U.S. Cl. CPC B01J 23/52; B01J 21/18; B01J 35/0006; B01J 37/035; C02F 1/725; C02F 2101/003

(57) ABSTRACT

Disclosed herein are embodiments of a metallic composite that is made using embodiments of a facile, efficient method. Certain embodiments of the disclosed method of making the composite can comprise a one-step, room temperature synthetic procedure, and other embodiments can comprise a two-step synthetic procedure. Also disclosed herein are embodiments of a method of using the disclosed composite, such as for fluid purification via contaminant degradation, or in biological sensor applications.

### CROSS REFERENCE TO RELATED APPLICATION

This application claims the benefit of U.S. Provisional Patent Application No. 61/899,626, filed Nov. 4, 2013, which is incorporated herein by reference in its entirety.

### ACKNOWLEDGMENT OF GOVERNMENT SUPPORT

This invention was made with government support under Contract Number 1057565 awarded by the National Science Foundation. The government has certain rights in the invention.

### FIELD

The present disclosure concerns embodiments of a method for making and using a composite material.

### BACKGROUND

Many common compounds, or by-products of compounds, are considered harmful contaminants that contaminate the environment and are hazardous to numerous organisms. Trichloroethylene (TCE), a carcinogenic, neurological, and reproductive toxin, is one of the most common industrial solvents and a contaminant of hazardous waste sites, groundwater, and drinking water. Once introduced into the groundwater system via chemical spills or leaks, TCE is very difficult to remove as it is progressively solubilized as a contaminant plume. Conventional pump-and-treat methods to remove TCE, such as granular activated carbon adsorption and air stripping, merely displace TCE into a different phase, rather than degrading the TCE.

2,4,6-trinitrotoluene (TNT) is the most widely used military explosive because of its low melting point, stability, low sensitivity, and relatively safe methods of manufacture. Soil and water contamination by TNT, however, has resulted from munitions manufacturing, loading, assembling, and packing operations. TNT is an environmental hazard because it has toxicological effects on a number of organisms and also is mutagenic. Disposing large quantities of TNT in an environmentally acceptable manner poses serious difficulties. The current remediation method for explosives-contaminated soils is incineration, which is a costly, energy-intensive process that destroys much of the soil, leaving ash as the primary residue.

2-Phenacyl chloride (2-CAP) is supplied to paramilitary and police forces in a small pressurized aerosol known as “tear gas.” This compound irritates the mucous membranes (oral, nasal, conjunctival and tracheobronchial). It also can give rise to more generalized reactions, such as syncope and temporary loss of balance and orientation. At high concentrations, 2-CAP has caused corneal epithelial damage and chemosis.

The contaminants provided above are exemplary organic contaminants that plague the environment and require effective methods of removal. Catalytic hydrodechlorination (HDC) of TCE in water to ethane is an alternative and effective treatment. Recently, palladium (Pd) has been demonstrated to be an excellent HDC catalyst; however, known Pd catalysts can only be used at certain sites (or in certain applications), as common groundwater ions, particularly sulfide and chloride, deactivate the catalyst.

Accordingly, a need exists in the art to develop stable, economically-feasible, catalysts that are capable of purifying fluids containing harmful contaminants. Facile methods for making these catalysts also are needed, including methods that can be scaled up or down and that do not require extreme reaction conditions.

### SUMMARY

Disclosed herein are embodiments of a method of making and/or using a composite material. In one embodiment, the method comprises combining, at a temperature ranging from 19° C. to 200° C. (such as about 19° C. to 110° C.), a first metallic precursor comprising a Group 8, Group 9, or a Group 10 element, a second metallic precursor comprising a Group 11 or Group 13 metal, and a solid support material to form a mixture maintained at a temperature ranging from about 19° C. to 110° C.; and isolating a composite material having a heterostructure or alloy structure from the mixture, wherein the mixture is free of surfactants or extraneous reducing agents. In some embodiments, the temperature ranges from about 100° C. to 110° C. and in some other embodiments, the temperature ranges from 19° C. to 25° C. In particular disclosed embodiments, the first metallic precursor and the second metallic precursor can be dissolved, dispersed, or suspended in a non-toxic solvent. In exemplary embodiments, the non-toxic solvent can be acetone.

The first metallic precursor can comprise a metal selected from Ni, Pd, Pt, Ir, Rh, Ru, or combinations or ions thereof. For example, the first metallic precursor can comprise Pd⁰, Pd⁺² or Pd⁺⁴. In some embodiments, the first metallic precursor is selected from Pd(OAc)₂, Pd(acac)₂, PdCl₂, Pd(dba)₂, Pd(OH)₂, Pd nanocrystals (or Pd nanoparticles), or combinations thereof. In some embodiments, the second metallic precursor can comprise a metal selected from Cu, Ag, Au, Al, In, or combinations or ions thereof. For example, the second metallic precursor can comprise Au⁰, Au⁺² or Au⁺⁵. Exemplary embodiments concern second metallic precursors selected from HAuCl₄, Cu(NO₃)₂, AgNO₃, aluminum nanoparticles, or combinations thereof.

The solid support material can be selected from graphene, graphite, carbon black, carbon fiber, carbon aerogel, carbon nanotubes, activated carbon, alumina (e.g., α-Al₂O₃), silica (e.g., MCM-41), zeolites, magnetite, or combinations thereof. In some embodiments, the solid support is exfoliated graphene, carbon black, or granular activated carbon having a mesh size ranging from 8 to 40 mesh, as well as alumina microscale or nanoscale particles.

In some embodiments of the method of making the composite, the first metallic precursor and the second metallic precursor are mixed with the solid support material substantially simultaneously. Alternatively, the first metallic precursor and the second metallic precursor can be mixed with the solid support material sequentially in any ordered sequence. Some embodiments concern combining the first metallic precursor and the solid support material and then mixing these components with the second metallic precursor. The method also can further comprising heating the first metallic precursor and the solid support material prior to mixing with the second metallic precursor.

Exemplary methods of making the composite include a method for making a bi-metallic composite having an alloy structure, comprising combining a Pd⁺²-containing reagent with an Au⁺⁵-containing reagent and a solid support material selected from graphene, graphite, carbon fiber, carbon aerogel, carbon nanotubes, activated carbon, alumina (e.g., α-Al₂O₃), silica (e.g., MCM-41), zeolites, magnetite, or combinations thereof, and mixing the Pd⁺²-containing reagent, the Au⁺⁵-containing reagent, and the solid support material for a period of time effective to make the bi-metallic composite.

In other embodiments, a method for making a bi-metallic composite having a heterostructure is disclosed, the method comprising combining a Pd⁺²-containing reagent with a solid support material selected from graphene, graphite, carbon fiber, carbon aerogel, carbon nanotubes, activated carbon, carbon black, alumina (e.g., α-Al₂O₃), silica (e.g., MCM-41), zeolites, magnetite, or combinations thereof, heating the Pd⁺²-containing reagent and the solid support material to promote Pd metal deposition on the solid support material, and adding an Au⁺⁵-containing reagent to the Pd⁺²-containing reagent and the solid support material. Heating can comprise heating at a temperature ranging from 80° C. to 200° C.

Also disclosed herein is a bi-metallic composite comprising a first metal component selected from Pd, Pt, Rh, Ru, or Ni; a second metal component selected from Au, Ag, Al, or Cu; and a support material selected from graphene, graphite, carbon fiber, carbon aerogel, carbon nanotubes, activated carbon, alumina (e.g., α-Al₂O₃), silica (e.g., MCM-41), zeolites, magnetite, or combinations thereof. In some embodiments, the bi-metallic composite has a heterostructure structure. The second metal component can substantially coat the first metal component, or it can partially coat the first metal component. In other embodiments, the bi-metallic composite can have an alloy structure.

Disclosed herein are embodiments of a method comprising exposing a contaminant to the bi-metallic composite. The contaminant may be in a fluid, such as a liquid. The contaminant typically comprises one or more carbon-hydrogen bonds, carbon-nitrogen bonds, nitrogen-nitrogen bonds, carbon-halide bonds (e.g., carbon-chloride, carbon-iodide, carbon-fluoride, or carbon-bromide bonds), or combinations thereof. The contaminant can be selected from a halogenated organic compound, a nitro-containing compound, an N-nitrosoamine, an oxyanion-containing compound, or combinations thereof. In other disclosed embodiments, the composite may be used as a biological sensor. The composite also can be used as an ion-gated field effect transistor.

The foregoing and other objects, features, and advantages of the invention will become more apparent from the following detailed description, which proceeds with reference to the accompanying figures.

### BRIEF DESCRIPTION OF THE DRAWINGS

FIG. 1 is a low resolution Transmission Electron Microcopy (TEM) micrograph of a graphene-supported Au—Pd composite having a heterostructure that was made using an embodiment of the disclosed method.

FIG. 2 is a high resolution TEM micrograph of the Au—Pd composite of FIG. 1.

FIG. 3 is an energy-dispersive X-ray (EDX) spectrum of the Au—Pd composite illustrated in FIGS. 1 and 2.

FIG. 4 is a low resolution TEM micrograph of a graphene-supported Au—Pd alloy composite that was made using an embodiment of the disclosed method.

FIG. 5 is a high resolution micrograph of the Au—Pd alloy composite illustrated in FIG. 4.

FIG. 6 is an EDX spectrum of the deposited Au—Pd alloy composite illustrated in FIGS. 4 and 5.

FIG. 7 is a low resolution TEM micrograph of a carbon black-supported Au—Pd alloy that was made using an embodiment of the disclosed method.

FIG. 8 is a high resolution micrograph of the Au—Pd alloy illustrated in FIG. 7.

FIG. 9 is an EDX spectrum of the deposited Au—Pd alloy illustrated in FIGS. 7 and 8.

FIG. 10 is a graph (concentration of pollutant/initial concentration [C/C0] versus time [minutes]) illustrating degradation curves of TCE obtained by exposing TCE to three different embodiments of the disclosed composite, as well as graphene alone.

FIG. 11 is a graph (TNT concentration [μM] versus time [minutes]) illustrating degradation curves of TNT obtained by exposing TNT to three different embodiments of the disclosed composite, as well as graphene alone.

FIG. 12 is a graph (concentration of pollutant/initial concentration [C/C0] versus time [minutes]) illustrating degradation curves of 2-CAP obtained by exposing 2-CAP to three different embodiments of the disclosed composite, as well as graphene alone.

FIG. 13 is a high-angle annular dark-field (HAADF) image of a graphene supported Au—Pd composite wherein the deposited Au—Pd has an alloy structure.

FIG. 14 is a dark field image of graphene-supported Au—Pd composite wherein the deposited Au—Pd has an alloy structure.

FIG. 15 is an elemental map obtained from gold mapping of graphene-supported Au—Pd composite wherein the deposited Au—Pd has an alloy structure.

FIG. 16 is an elemental map obtained from palladium mapping of the graphene-supported Au—Pd composite wherein the deposited Au—Pd has an alloy structure.

FIG. 17 is a high-angle annular dark-field (HAADF) image of a graphene-supported Au—Pd composite having a heterostructure.

FIG. 18 is a dark field image of the graphene-supported Au—Pd composite having a heterostructure.

FIG. 19 is an elemental map obtained from gold mapping of the graphene-supported Au—Pd composite having a heterostructure.

FIG. 20 is an elemental map obtained from palladium mapping of the graphene-supported Au—Pd composite having a heterostructure.

FIG. 21 is a low resolution TEM micrograph of a graphene-Pd hybrid formed after a reaction time of four hours.

FIG. 22 is a low resolution TEM micrograph of a graphene-Pd hybrid formed after a reaction time of eight hours.

FIG. 23 is a low resolution TEM micrograph of a graphene-Pd hybrid formed after a reaction time of twelve hours.

FIG. 24 is a high resolution TEM micrograph of a graphene-Pd hybrid.

FIG. 25 is an image of a selected area electron diffraction (SAED) pattern obtained from the graphene-Pd hybrid of FIG. 24.

FIG. 26 is an energy-dispersive X-ray (EDX) spectrum of the deposited Pd nanocrystal shown in FIG. 24.

FIG. 27 is a low resolution TEM micrograph of a graphene-Au hybrid, which illustrates that the deposited Au does not have a nanoparticle form.

FIG. 28 is another low resolution TEM micrograph of a graphene-Au hybrid, which illustrates that the deposited Au does not have a nanoparticle form.

FIG. 29 is a low resolution TEM micrograph of a reduced graphene oxide supported AuPd alloy.

FIG. 30 is a high resolution TEM micrograph of a reduced graphene oxide supported AuPd alloy.

FIG. 31 is a SEM image of an activated carbon supported AuPd catalyst with high loading density.

FIG. 32 is a SEM image of an activated carbon supported AuPd catalyst with relatively low loading density.

FIG. 33 is an EDX spectrum illustrating results obtained from EDX analysis of an AuPd particle attached to an activated carbon support.

FIG. 34 is a graph (concentration of pollutant/initial concentration [C/C₀] versus time [minutes]) illustrating degradation curves of TCE obtained by exposing TCE to four different embodiments of the disclosed composite, as well as exfoliated graphene alone.

FIG. 35 is a graph (concentration of pollutant/initial concentration [C/C₀] versus time [minutes]) illustrating degradation curves of TNT obtained by exposing TNT to three different embodiments of the disclosed composite, as well as exfoliated graphene alone.

FIG. 36 is a graph (concentration of pollutant/initial concentration [C/C₀] versus time [minutes]) illustrating degradation curves of 2-CAP obtained by exposing 2-CAP to four different embodiments of the disclosed composite, as well as exfoliated graphene alone.

FIG. 37 is a graph (concentration of pollutant/initial concentration [C/C₀] versus time [minutes]) illustrating degradation curves of TCE by GAC comprising an Au—Pd bi-metallic system, wherein embodiments of different Au—Pd loading densities were used.

FIG. 38 is a graph (concentration of pollutant/initial concentration [C/C₀] versus time [minutes]) illustrating degradation curves of TCE using three cyclability tests.

FIG. 39 is an SEM image of an activated carbon supported Au—Pd composite before a five-cycle TCE degradation test.

FIG. 40 is an SEM image of an activated carbon supported Au—Pd composite after an eight-cycle TCE degradation test.

FIGS. 41A-41D are images of results obtained using simulations of the bonding effect of an H₂ molecule near a (Au—Pd)₇ cluster absorbed on a perfect graphene sheet; FIG. 41A illustrates the optimized structure of (Au—Pd)₇ on graphene; FIG. 41B illustrates the effect of placing the molecule H₂ close to the Au atoms, thereby forming a physical adsorption with a binding energy of −0.079 eV; FIG. 41C illustrates the effect of placing the H₂ molecule close to a Pd atom in the cluster, thereby forming a physical-chemical hybrid adsorption with a binding energy of −0.630 eV; and FIG. 41D illustrates the effect of placing the H₂ molecule close to a hole encircled by surface Pd atoms, thereby forming a chemical adsorption with a binding energy of −1.0768 eV.

FIGS. 42A and 42B illustrate clusters of (Au—Pd)₇ on defective graphene with different vacancy densities; FIG. 42A illustrates a cluster with low density and FIG. 42B illustrates a cluster with high density.

### DETAILED DESCRIPTION

### I. Introduction and Terms

Disclosed herein are embodiments of a composite material, with particular embodiments being useful as a catalytic composite material. Also disclosed are embodiments of methods for making and using the disclosed composite. The disclosed composite can be used for a variety of purposes, such as to purify fluids that contain contaminants, such as organic contaminants (e.g., TCE, TNT, 2-CAP, and the like), biological assays (such as biological sensors), and or as ion-gated field effect transistors. Disclosed embodiments of the method of making the disclosed composite provide an advantage over the art as certain embodiments are facile to perform (e.g., room temperature reactions conditions may be used), they are implemented at low costs (e.g., low-cost reagents and scalable production), they do not require surfactants and/or extraneous reducing agents, and they are environmentally benign (e.g., non-toxic precursors and solvents can be used to make the composites). Additionally, the method can be modified to provide nanoscale, microscale, and or macroscale embodiments of the disclosed composite. For example, in some embodiments, the composite can be produced on a milligram, gram, or kilogram scale.

Conventional fluid treatment methods known in the art typically are limited in application as many treatment methods utilize monometallic Pd catalysts that are readily deactivated by common ions found in, for example, groundwater (e.g., sulfide, chloride, and the like). Additionally, conventional pump-and-treat methods to remove contaminants like TCE merely displace TCE into a different phase, but do not completely deactivate and/or degrade the TCE. Methods for making bi-metallic Pd-containing catalysts disclosed in the art require additional reagents, such as surfactants and/or reducing agents, in order to make a suitable catalyst. The method disclosed herein requires no additional reagents other than the disclosed metallic precursors and the disclosed support material, and a solvent. Exemplary embodiments utilize non-toxic solvents, such as, but not limited to, acetone.

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from prior art, the embodiment numbers are not approximates unless the word “about” is recited. If a range is provided and one end of the range is expressly qualified by the term “about” and the other range is not expressly qualified by the term “about,” then only the end of the range qualified by “about” is an approximation. Furthermore, not all alternatives recited herein are equivalents.

In order to facilitate review of the various examples of this disclosure, the following explanations of specific terms are provided:

“2-CAP”: 2-Phenacyl chloride

“acac”: acetylacetonate

“COD”: cyclooctadiene

“dba”: dibenzylideneacetone

“OAc”: Acetate

“TCE”: Trichloroethylene

“TNT”: 2,4,6-trinitrotoluene

### II. Composite Components

Disclosed herein are composite components suitable for making composites according to the method embodiments disclosed herein. The composite components include metallic precursors and solid support materials. Metallic precursor embodiments can include at least two different metallic precursors, such as a first metallic precursor and a second metallic precursor. The composites disclosed herein are more economical to make and are more stable than conventional composites, such as commercial Pd—Al₂O₃ substrate catalysts.

The first metallic precursor may be any compound comprising a periodic Group 8, Group 9, or Group 10 metal. For example, the first metallic precursor may comprise a metal selected from Ni, Pd, Pt, Ir, Rh, Ru, or combinations thereof and in any suitable oxidation state (e.g., 0, +1, +2, +3, +4, +5, +6, and higher). In some embodiments, the first metallic precursor comprises Pd metal or an ion thereof (e.g., Pd⁺² or Pd⁺⁴). In exemplary embodiments, the first metallic precursor comprises Pd⁺².

The first metallic precursor also may comprise one or more ligands. Exemplary ligands include σ-ligands, π-ligands, or a 3-, 4-, 5-, 6-, 7-, or 8-electron ligand, or combinations thereof. Suitable ligands include, but are not limited to, halides, hydrogen, methylallyl groups, acetate, hydroxy, acac, dba, CO, COD, phosphine ligands, and the like. Suitable exemplary species of the first metallic precursor include, but are not limited to, Pd(OAc)₂, Pd(acac)₂, PdX₂ (wherein X is selected from Cl, Br, I, and F), Pd(dba)₂, Pd(OH)₂, Pd nanoparticles, NiX₂ (wherein X is selected from Cl, Br, I, and F), Ni(OAc)₂, Ni(acac)₂, Ni(OH)₂, Ni nanoparticles, Pt(acac)₂, PtX₂ (wherein X is selected from Cl, Br, I, and F), Pt nanoparticles, Ir(acac)₃, RuX₃ (wherein X is selected from Cl, Br, I, and F), Ru(acac)₃, [Ph₃P]₂Ru(CO)₂Cl₂, Ru(methylallyl)₂(COD), Ru nanoparticles, Rh(acac)₃, RhCl(COD), RhX₃ (wherein X is selected from Cl, Br, I, and F), [Ph₃P]₃RhCl, Rh nanoparticles, or combinations thereof. In working embodiments, the first metallic precursor was Pd(OAc)₂ or Pd(acac)₂.

The second metallic precursor may be any compound comprising a Group 11 or Group 13 metal. For example, the second metallic precursor may comprise a metal selected from Cu, Ag, Au, In, or combinations thereof and having any suitable oxidation state (e.g., 0, +1, +2, +3, and +5). In some embodiments, the second metallic precursor comprises Au metal or an ion thereof (e.g., Au⁺² or Au⁺⁵). In exemplary embodiments, the second metallic precursor comprises Au⁺⁵.

The second metallic precursor also may comprise one or more ligands. Exemplary ligands include σ-ligands, π-ligands, or a 3-, 4-, 5-, 6-, 7-, or 8-electron ligand, or combinations thereof. Suitable ligands are disclosed herein. Suitable exemplary species of the second metallic precursor include, but are not limited to HAuCl₄ (and hydrates thereof), CuXₙ (wherein X is selected from Cl, Br, I, and F, and n is 1 or 2), Cu(NO₃)₂, Cu(OAc)₂, Cu(OTf)₂, Cu(acac)₂, Cu nanoparticles, AgNO₃, AgOAc, AgX (wherein X is selected from Cl, Br, I, and F), Ag₂CO₃, Ag nanoparticles, Al nanoparticles, In₂O₃, In(OH)₃, or combinations thereof. In working embodiments, the second metallic precursor was HAuCl₄.4H₂O.

The solid support may be any material suitable for associating with the metallic precursors (or a metal derived therefrom) disclosed herein. In particular disclosed embodiments, associated may include covalent or electrostatic binding, or any other type of chemical or physical bonding. In some embodiments, the binding energy between the deposited metal component and the solid support may be weaker than a typical chemical bond (e.g., covalent bond); thus, the intrinsic electronic structure of the solid support material may be preserved. The solid support may be a carbon-based material. The carbon-based material preferably has a relatively high surface area, electric conductivity, tensile strength, chemical stability, and combinations of these attributes. Exemplary carbon-based materials contemplated herein include, but are not limited to graphene, graphite, carbon black, carbon fiber, carbon aerogel, carbon nanotubes, activated carbon (e.g., granular activated carbon), or combinations thereof. Other examples of suitable solid supports contemplated by the present disclosure include, but are not limited to, alumina-based supports (e.g., α-Al₂O₃, microscale or nanoscale alumina particles), silica (e.g., MCM-41), zeolites, granular activated carbon having all types of mesh size (such as a mesh size ranging from 8-40 mesh, 8-20 mesh, and 20-40 mesh), magnetite, and the like.

In some embodiments wherein graphene is used as the carbon-based support material, the graphene may be exfoliated and thus isolated and used as a thin sheet. Solely by way of example, exfoliated graphene may be made by heating graphite at a temperature of 1000° C. and maintaining the graphite under an inert atmosphere (e.g., an atmosphere of H₂ and Ar) for a time period of at least 1 minute (e.g., such as 1 minute to 60 minutes, or 1 minute to 30 minutes, or 1 minute to 10 minutes) to produce thermally expanded graphite. The thermally expanded graphite may then be mixed with a solvent, such as N-methylpyrrolidone (NMP). Thin sheets of graphene may be exfoliated from the thermally expanded graphite using durative sonication and centrifugation.

The first and/or second metallic precursor may be selected to provide deposited metals capable of associating with the solid support. Preferably, a first metal component (obtained from reduction of a first metallic precursor comprising a metal ion) is associated with the solid support, followed by association of the first metal with a second metal (obtained from reduction of a second metallic precursor comprising a metal ion). In some embodiments, both a first and second metal may associate with the support material. Without being limited to a particular theory of operation, it is currently believed that mixing the first and second metallic precursors with the support material can promote conversion of the first and/or second metallic precursors to the deposited metallic form of each component. This conversion may involve reduction of the precursors, which is promoted by the solid support material. The rate of conversion may be controlled by selecting a first and/or second metallic precursor that comprises a ligand component, such as those disclosed herein, that requires longer time periods to be displaced (thereby allowing reduction of the metallic precursor to the corresponding metal and reducing agglomeration of the metal components). The properties of the composites disclosed herein (e.g., crystal structure, morphology, size distribution, loading densities, elemental ratios, and chemical and/or electronic states can be determined using methods known to those of ordinary skill in the art, such as SEM equipped with EDS, TEM equipped with electron diffraction pattern (EDP) capability, STEM/EDS, electron energy loss spectroscopy (EELS), X-ray photospectroscopy (XPS), X-ray diffraction (XRD) chemical analysis, the Brunauer-Emmett-Teller (BET) gas adsorption (e.g., to determine surface area), and the Barrett-Joyner-Halenda (BJH) analysis (e.g., to determine pore size and volume). In some embodiments, the combination of the first and second metallic precursors can be selected to facilitate degradation of particular classes of contaminants. That is, particular species of each of the first and second metallic precursors can be selected based on the type of contaminant that is to be degraded. This ability to selectively tune the reactivity of the disclosed bi-metallic composite is unique to the present disclosure.

### III. Method of Making the Composite

Disclosed herein are embodiments of a method for making a composite material. The method may comprise hybridizing a solid support material with a metallic material. The method may be performed on any scale, such as nanoscale, microscale, macroscale, and the like. Embodiments of the disclosed method may be used to make a composite having a particular structure, with some embodiments having a heterostructure and some embodiments having an alloy structure. Method of making embodiments disclosed herein may comprise only one synthetic step, with some embodiments comprising more than one synthetic step. The embodiments disclosed herein are not limited to one or two steps and may include additional synthetic steps. The number of synthetic steps may correspond to the type of composite structure made in the method. For example, a one-step method can be used to make an alloy-structured composite, whereas a two-step method can be used to make a heterostructured-composite. The methods disclosed herein are more economical and more environmentally-friendly than conventional methods of making conventional monometallic Pd or Pd-based bi-metallic compounds. The methods disclosed herein also are scalable for mass production, unlike conventional methods.

Certain embodiments of the disclosed method concern providing two or more metallic precursors that are selected as being suitable for making a metal-containing composite capable of catalyzing contaminants degradation in fluids (such as liquids), as well as composites capable of being used as biological sensors and/or ion-gated field effect transistors. The method typically involves mixing a first metallic precursor and a second metallic precursor; however, the disclosed method is not limited to using only two metallic precursors and some embodiments concern mixing three, four, five, or more metallic precursors.

The method can also comprise combining a first metallic precursor, a second metallic precursor, a non-toxic solvent, and a solid support material. In some embodiments, the first metallic precursor may be combined with the second metallic precursor and the solid support material substantially simultaneously. For example, the first metallic precursor can be combined with the solid support material and then the second metallic precursor may be added substantially immediately after these two components are combined. Another order of addition contemplated by the present disclosure includes combining the first metallic precursor with the second metallic precursor and then adding the solid support material substantially immediately after these two components are combined. In other embodiments, all three components (e.g., the first metallic precursor, the second metallic precursor, and the solid support material) may be combined at the same time.

Alternatively, the first metallic precursor may be combined with the second metallic precursor and the solid support material sequentially in any ordered sequence. For example, the first metallic precursor can first be mixed with the solid support material to form a composition, and then the second metallic precursor can be added to the composition. Yet another exemplary order of addition includes first combining the first metallic precursor with the second metallic precursor and then adding the solid support material.

Each of the metallic precursors and the solid support material may be provided as a solution in a solvent suitable for dissolving the respective reagents. Typically the solvent is a polar, aprotic organic solvent (e.g., acetone, dichloromethane, tetrahydrofuran, ethylacetate, dimethylformamide, acetonitrile, or combinations thereof). The first metallic precursor typically may be provided at a concentration of greater than zero to 2.5 mg/mL, such as 0.3 mg/mL to 2.0 mg/mL, or 0.6 mg/mL to 1.2 mg/mL. In some embodiments, the second metallic precursor may be provided at a concentration of greater than zero to 2 mg/mL, such as 0.05 mg/mL to 1.5 mg/mL, or 0.1 mg/mL to 1 mg/mL. In some embodiments, the solid support may be provided at a concentration ranging from greater than zero to 1 mg/mL, such as 0.1 mg/mL to 0.75 mg/mL, or 0.25 mg/mL to 0.5 mg/mL. These components may be combined in the solvent for an amount of time and at a temperature sufficient to facilitate composite formation. In some embodiments, the components are stirred for at least 1 hour to 24 hours, more typically for at least 1 hour to 18 hours, even more typically for at least 1 hour to 12 hours. The components may be stirred at room temperature, such as at temperatures ranging from 19° C. to 24° C. (e.g., 20° C. to 24° C., or 22° C. to 24° C.). The components may be manually or mechanically mixed.

Certain disclosed embodiments may further comprise heating the reaction mixture for a time period effective to make the desired materials. For example, in embodiments comprising a mixture of a first metallic precursor and the solid support material, typically as a solution in a solvent disclosed herein, the mixture may be heated to a temperature sufficient to evaporate any solvent present in the mixture and/or to promote reduction of the first metallic precursor. The temperature can be modified depending on the solvent used and/or the type of ligand used with the first metallic precursor. In particular embodiments, the components may be heated at a temperature above 60° C. (such as 80° C. to 200° C., or 100° C. to 150° C., or 110° C. to 120° C.). In some embodiments, such as those using acetone as the solvent, the components can be heated at temperatures ranging from 100° C. to 120° C., such as 105° C. to 115° C., or 108° C. to 112° C. In an independent embodiment, the components are heated at a temperature below 115° C., such as from about 19° C. to 110° C. Embodiments of the mixture may be heated for at least 1 hour to 9 hours, more typically for at least 1 hour to 8 hours, or at least 1 hour to 7 hours. Again, the heating time may be modified depending on the solvent used and the extent/rate of reduction desired.

In certain embodiments of the method, the second metallic precursor may be added to the mixture comprising the first metallic precursor and the solid support material after the mixture has been heated and cooled to a temperature lower than 50° C., such as to an ambient temperature. For example, temperatures ranging from 19° C. to 25° C. (e.g., 20° C. to 24° C., or 22° C. to 24° C.).

The second metallic precursor may be added neat or as a solution. The resulting mixture comprising the first and second metallic precursors and the solid support material may then be mixed for at least 1 hour to 24 hours, more typically for at least 1 hour to 18 hours, even more typically for at least 1 hour to 12 hours. The components may be mixed at temperatures ranging from 19° C. to 25° C. (e.g., 20° C. to 24° C., or 22° C. to 24° C.).

The composite formed by the disclosed method may be isolated from solution, or it may be kept as a solution. In some embodiments, the composite is dried, such as by flowing an inert gas over the composite, by removing the solvent in vacuo, or by leaving the composite exposed to the atmosphere. The dried composite may be isolated as a powder on a solid support. The isolated powder typically comprises particles having diameters ranging from 5 nm to 30 nm, more typically from 10 nm to 30 nm, or 15 nm to 25 nm.

Exemplary embodiments for forming a heterostructured composite include mixing the first metallic precursor with the solid support material in a solvent and then heating this composition at 110° C. for 7 hours. The second metallic precursor may then be added neat, or as a solution, and the resulting mixture is stirred for 12 hours at room temperature, thereby producing the heterostructured composite. The heterostructured composite may comprise deposited crystals, or particles (such as nanocrystals or nanoparticles), of a first metal component formed from the first metallic precursor. The deposited crystals (or particles) comprise an outer coating formed by deposition of a different metal component provided by the second metallic precursor. The outer coating may partially coat the deposited metal crystal or particle, or may substantially completely coat the deposited metal crystal or particle. The crystals (or particles) produced from the first metallic precursor often are nanocrystals (or nanoparticles) having at least one dimension measured in nanometers, such as a diameter ranging from 5 nm to 30 nm, more typically from 10 nm to 30 nm, or 15 nm to 25 nm.

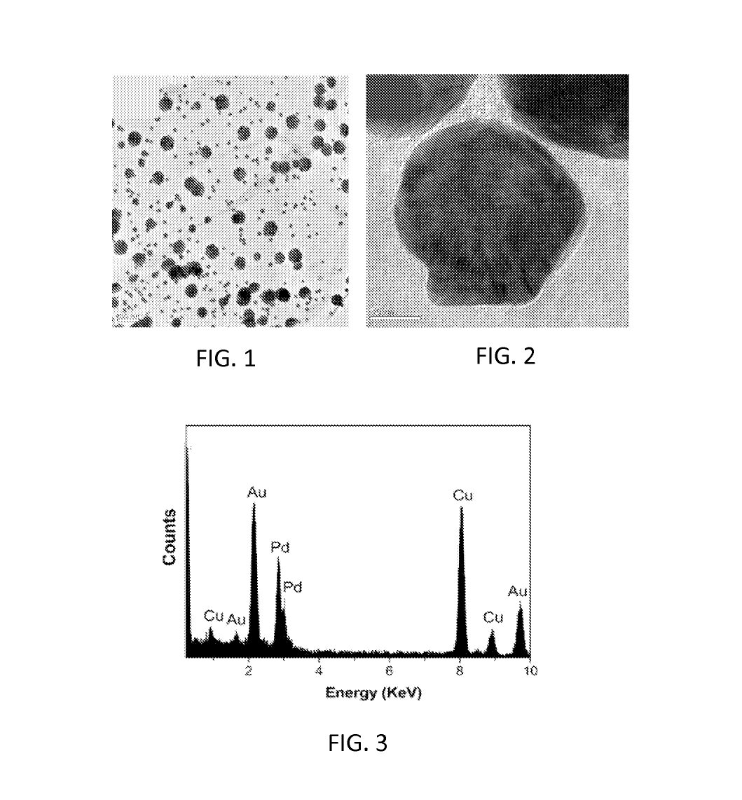

An exemplary embodiment of the disclosed heterostructured composite is shown in FIGS. 1-3. FIGS. 1 and 2 are TEM micrographs of a heterostructured composite comprising a graphene sheet with Pd nanocrystals deposited thereon and further comprising an outer coating of Au metal. FIG. 3 is an energy-dispersive X-ray spectrum of the heterostructured composite, which illustrates that both Pd and Au are present in the particles within the composite.

Exemplary embodiments for forming an alloy composite include mixing the first metallic precursor, the second metallic precursor, and the solid support material in a solvent for 12 hours at room temperature. The alloy composite may comprise one or more crystals (or particles), often nanocrystals (or nanoparticles), comprising metals formed from the first and second metallic precursors. The crystals (or particles) typically may comprise at least 12% to 88% of the first metallic precursor and at least 88% to 12% of the second metallic precursor. More typically, the crystals (or particles) may comprise at least 50% to 88% of the first metallic precursor and at least 12% to 50% of the second metallic precursor.

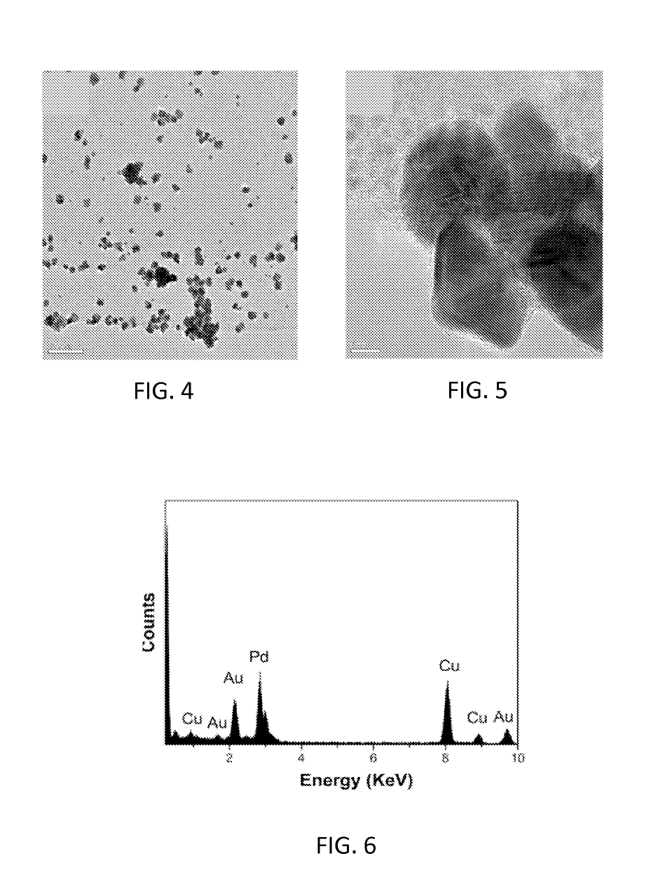

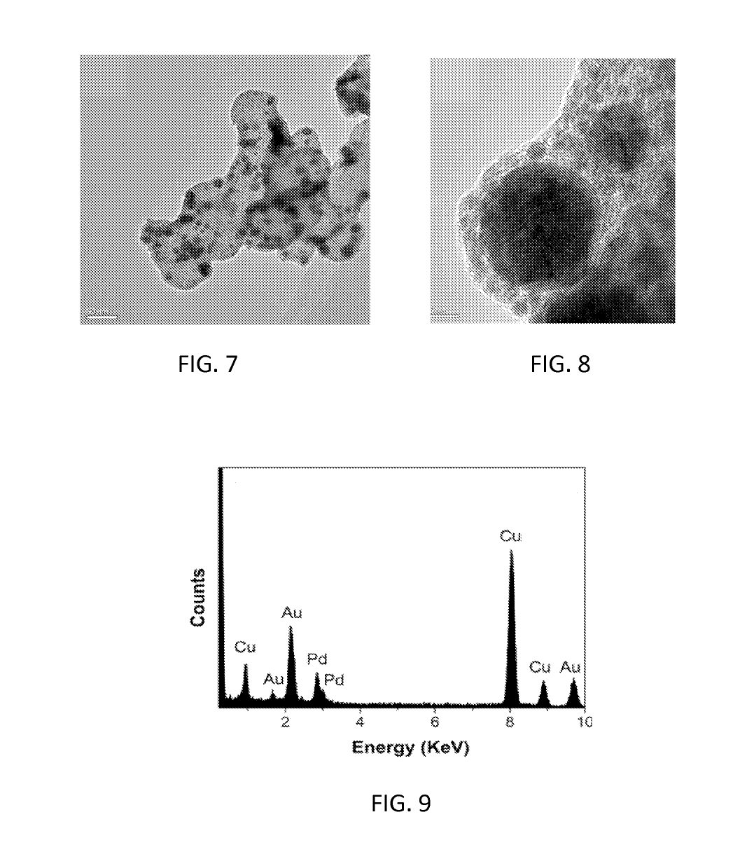

An exemplary embodiment of the disclosed alloy composite is shown in FIGS. 4 and 5. FIGS. 4 and 5 are TEM micrographs of an alloy structured composite comprising a graphene sheet with Pd and Au deposited thereon. FIG. 6 is an energy-dispersive X-ray spectrum of the alloy structured composite, which illustrates that both Pd and Au are present in the particles within the composite. Yet another embodiment is provided in FIGS. 7-9. These figures are similar to FIGS. 4-6, but show results obtained from an alloy composite comprising carbon black as a support material. In an independent embodiment, the composite is other than, or is not, a Pt—Pd/graphene hybrid composite.

In certain embodiments, the method for making the disclosed composite avoids using a surfactant or an extraneous reducing agent, as is required for certain known methods. In yet other embodiments, the method for making the disclosed composite avoids cooling at temperatures below room temperature (e.g., lower than 19° C.). In certain embodiments, using surfactants and/or reducing agents and cooling are avoided. These features of the presently disclosed technology therefore provide a substantial benefit when compared to known processes.

In some embodiments, the method consists of (or consists essentially of) combining a first metallic precursor comprising a Group 8, Group 9, or a Group 10 element, a second metallic precursor comprising a Group 11 or Group 13 metal, and a solid support material at a temperature substantially at or above room temperature to form a mixture, and isolating a composite material having a heterostructure or alloy structure from the mixture, wherein the mixture is free of surfactants or extraneous reducing agents.

### IV. Method of Using the Composite

Disclosed embodiments of the composite may be used as catalysts to purify fluids, such as liquids. For example, disclosed composites may be used for water purification to remove particular water contaminants from water sources, wastewater, and ground water without accumulation of problematic by-products or significant susceptibility of the composite to poisoning by common components of natural water. In particular disclosed embodiments, the composite may be used to catalyze the reduction (or degradation) of a variety of contaminants. Without being limited to a particular theory of operation, it is currently believed that disclosed embodiments of the composite degrade contaminants by a chemical degradation process, such as hydrodehalogenation, hydodeoxygenation, N—N hydrogenolysis, and the like. The ability of the composites to degrade contaminants can be determined using methods and/or instrumentation, such as well-mixed batch reactors, H₂-saturated headspace sampling, serial sampling, and off-line analysis by gas or liquid chromatography. In particular disclosed embodiments, a stirred batch reactor with membrane-inlet mass spectrometry (MIMS) by diffusion sampling with polymer tubing that is permeable to volatile organic compounds (VOCs) can be used.

The disclosed composite may be used to catalyze the degradation of organic contaminants having one or more carbon-hydrogen bonds, one or more carbon-nitrogen bonds (e.g., caffeine or microcystin), one or more carbon-halogen bonds (e.g., carbon-chloride, carbon-iodide, carbon-fluoride, or carbon-bromide bonds), one or more nitrogen-nitrogen bonds, one or more carbon-carbon bonds, one or more carbon-oxygen bonds, or combinations thereof. In certain disclosed embodiments, the organic contaminant may be a halogenated organic compounds (e.g., carbon tetrachloride, TCE, trichloropropane (TCP), diatrizoate, and 2-CAP), nitro-containing contaminants (e.g., TNT), N-nitrosoamines (e.g., NDMA and azo dyes, such as acid orange 7, acid red 88, alcian yellow, alizarine yellow R, allura red AC, amaranth, amido black 10B, aniline yellow, azo violet, azorubine, biebrich scarlet, Bismarck brown R or Y, black 7984, brilliant black BN, brown FK, brown HT, chrysoine resorcinol, citrus red 2, congo red, Evans blue, fast yellow AB, hydroxynaphthol blue, methyl orange, methyl red, methyl yellow, sudan black, sudan I, II, III, or IV, sudan red, sudan yellow, methyl violet, tartrazine, trypan blue, methylene blue), or combinations thereof. Disclosed composite embodiments also may be used to degrade oxyanion-containing contaminants (e.g., nitrate, nitrite, perchlorate, and chlorate).

The disclosed composite is extremely effective in degrading contaminants, with some embodiments effectively causing contaminant degradation in a matter of minutes. The rate at which the disclosed composite effectuates contaminant degradation is an inventive and unexpected aspect of the present technology. In some embodiments, contaminants were completely degraded in fewer than five minutes. Some contaminants disclosed in certain working embodiments provided herein were nearly 50% degraded in under 10 seconds using the disclosed composite.

Disclosed embodiments of the composite may be configured for use in water treatment plants, groundwater sites and any other suitable facility that may require water purification. In some embodiments, the composite may be configured as a powder that can be used in a reactor column, or in a flow reactor, such as a continuous flow reactor and/or a batch-wise flow reactor. The disclosed composite also may be added to the particular fluid (e.g., liquid) that requires purification as a powder and the solution comprising the powder may be agitated to facilitate the purification process.

Additional applications exist for the disclosed composite. For example, the composite can serve as a sensor platform for biologically relevant processes and for monitoring the concentration of various analytes with high specificity and sensitivity. In some embodiments, one or more bio-recognition agents can be immobilized onto an electrode comprising the disclosed composite. Suitable immobilization techniques include, but are not limited to, spin coating, dip coating, and electro-deposition. The disclosed composite can be used in amperometric and/or voltammetric sensing. In such embodiments, an enzyme-based approach can be implemented wherein an enzyme and suitable co-factor are provided on the composite-containing electrode surface, which may further comprise an electron mediator. The metal components (e.g., a first metal component and a second metal component derived from the first and second metallic precursors) of the composite can improve electrochemical performance of the selected bio-recognition agent whereas the solid support material improves electron transport.

In other disclosed embodiments, the catalyst can be used to make ion-gated field effect transistors (FETs). For example, the support material can be used as a gate material. The solid support material may further comprise a bio-recognition agent, such as a protein. When the protein is utilized on the substrate, conformation changes can be detected and the charge distribution will shift and affect the current output of the FET, such as by distortion of the field present at the gate. In other embodiments, an FET comprising the support material does not comprise an attached protein and therefore functions in a mode where the sensor comprising the composite is used to monitor pH levels in surrounding areas, with changes in these levels corresponding to relevant biological processes.

### V. Working Embodiments

Working embodiments disclosed herein establish efficient TCE, TNT and 2-CAP degradation. The disclosed embodiments illustrate that the composite is suitable for degrading these particular contaminants, as well as any other contaminants disclosed herein.

Chemicals and Materials:

The chemicals and materials used in the following working examples include 1-methyl-2-pyrrolidone (NMP) anhydrous, 99.5% (Sigma-Aldrich); absolute, anhydrous ethyl alcohol (Pharmco-Aaper); Gold(III) chloride hydrate, HAuCl₄. 4H₂O, 99.999% (Sigma-Aldrich); Palladium (II) acetate, Pd(OAc)₂, 99.5% (Sigma-Aldrich); Palladium (II) acetylacetonate, Pd(acac)₂, 99.5% (Sigma-Aldrich); Expandable graphite (average diameter 300 μm, 99% purity, Beijing Invention Biology Engineering & New Material Co. Ltd., China); and Acetone, 99.6% (J.T.Baker).

Thermal Expansion and Liquid Exfoliation Process to Obtain Few-Layer Graphene:

Commercial expandable graphite was rapidly heated to 1000° C. and maintained for 60 seconds under the atmosphere of forming gas (5% H₂ and 95% Ar). The resulting expanded graphite (EG) was mixed with NMP. The few-layer graphene sheets were then exfoliated from the EG through durative sonication for 60 minutes (Misonix Sonicator 3000, 700 W power) followed by centrifugation at 300 rpm (900 g) for 30 minutes, forming a sustainable grey suspension. The solid exfoliated pristine graphene sheets were collected by centrifugation at 15,000 rpm for 3 minutes and separated.

One-Step Co-Precipitation Process for Producing Graphene Supported Au—Pd Alloy:

Three precursors, exfoliated graphene (5 mg), Pd(OAc)₂ (0.012 g), and HAuCl₄.4H₂O (10 μL), were dispersed in acetone (20 mL), then stirred for 12 hours at room temperature.

One-Step Co-Precipitation Process for Producing Reduced Graphene Oxide Supported

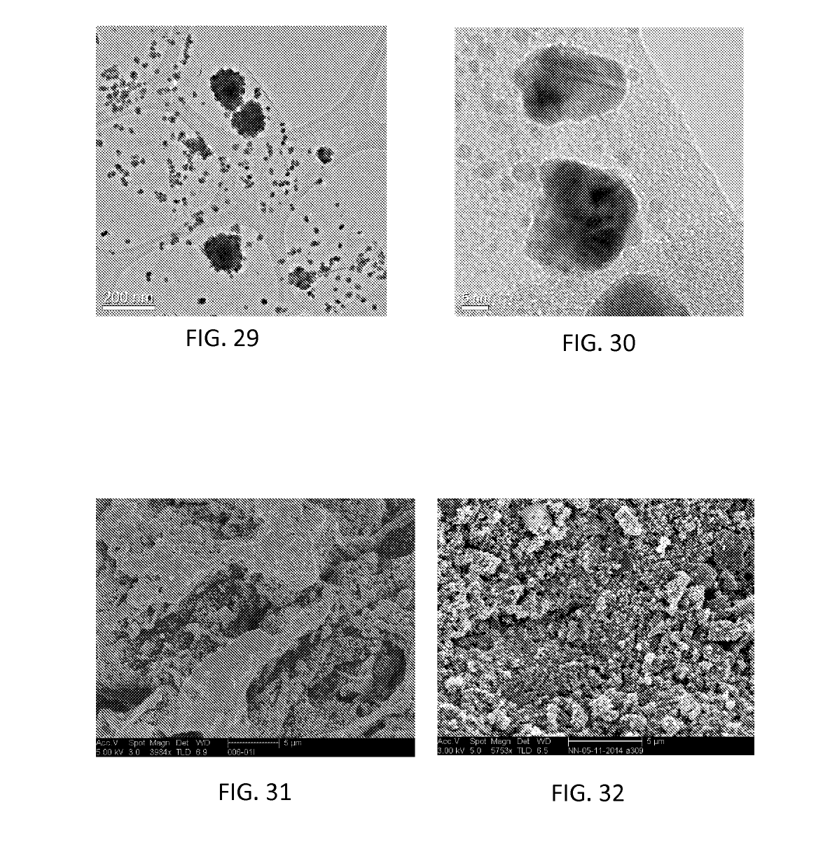

Au—Pd alloy. Three precursors, reduced graphene oxide (10 mg), Pd(OAc)₂ (0.4 mg) and HAuCl₄.4H₂O (0.05 mg) were dispersed in acetone (20 mL), then stirred for 12 hours at room temperature. FIGS. 29 and 30 illustrate TEM images of the hybridized reduced graphene with an Au—Pd alloy at low and high resolution, respectively. FIG. 30 confirms that the attached Au—Pd alloys are well crystalized.

One-Step Co-Precipitation Process for Producing Carbon Black Supported Au—Pd Alloy:

Three precursors, commercial carbon black (5 mg), Pd(OAc)₂ (0.012 g), and HAuCl₄.4H₂O (10 μL) were dispersed in acetone (20 mL), then stirred for 12 hours at room temperature.

One-Step Co-Precipitation Process for Producing Granular Activated Carbon Supported Au—

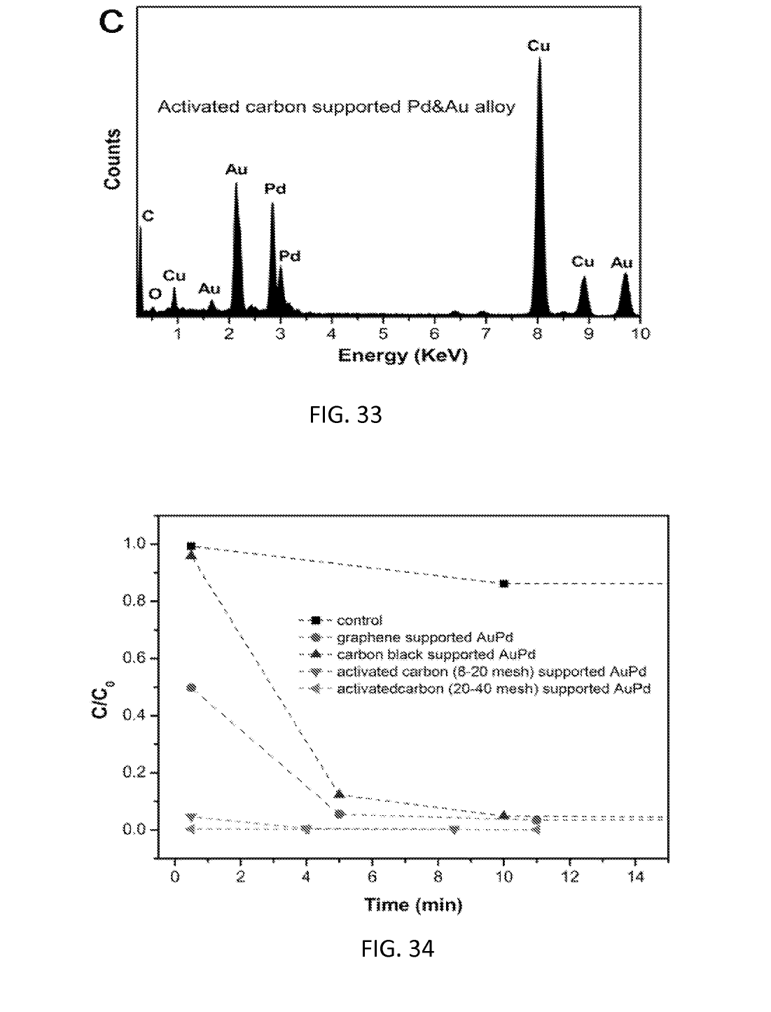

Pd alloy with very high loading density. Three precursors, granular activated carbon (10 mg) with two different size (8-20 mesh and 20-40 mesh), Pd(OAc)₂ (0.4 mg) and HAuCl₄. 4H₂O (0.05 mg) were dispersed in acetone (20 mL), then stirred for 12 hours at room temperature. The high loading density can be obtained by increasing the amount of the two precursors. FIG. 31 shows the SEM image of the synthesized granular activated carbon supported Au—Pd alloy with high loading density. FIG. 33 is an energy-dispersive X-ray (EDX) spectrum illustrating that both Pd and Au are present as a single Au—Pd nanocrystal. The Cu and C signals of FIG. 33 likely originate with the TEM grid and the very weak 0 signal likely is from the GAC.

One-step co-precipitation process for producing granular activated carbon supported Au—Pd alloy with relatively low loading density. Three precursors, granular activated carbon (40 mg) with two different size (8-20 mesh and 20-40 mesh), Pd(OAc)₂ (0.07 mg) and HAuCl₄. 4H₂O (0.01 mg) were dispersed in acetone (20 mL), then stirred for 12 hours at room temperature. The low loading density can be obtained by decreasing the amount of the two precursors used. FIG. 32 illustrates that granular activated carbon also can be supported with Au—Pd alloy at low loading density, thereby establishing a low-cost alternative method of making the composite. This result (in addition to the results illustrated in FIG. 31) suggest that it is feasible to systematically tailor the method of making the composite to achieve GAC-supported composites having increased performance while also providing a method of making the composite that is cost effective.

Two-Step Decoration Process for Producing Graphene Supported Au—Pd with Heterostructure:

In the first step for hybridizing graphene with Pd nanocrystals (NCs), the few-layer graphene sheets (5 mg), Pd(acac)₂ (0.015 g, 0.05 mmol), and acetone (20 mL) were mixed and magnetically stirred for 30 minutes. The mixture was then transferred to a closed stainless-steel autoclave with a Teflon-liner (25 mL in total capacity). The autoclave was heated to 110° C. and maintained at this temperature for 7 hours. Subsequently, Au NCs were deposited on the surface of the graphene/Pd hybrid by adding HAuCl₄.4H₂O (10 μL) and stirring for 12 hours at room temperature.

TCE Degradation Studies:

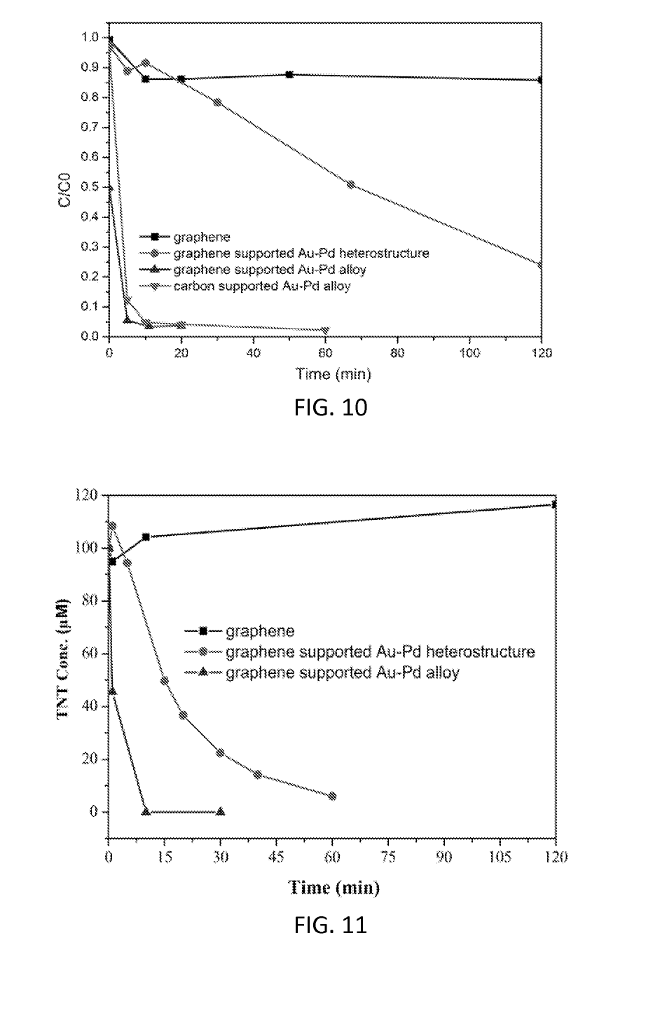

To confirm the efficacy of the disclosed composite as an efficient hydrodechlorination catalyst for degrading TCE, the reaction of each composite with TCE was monitored through headspace gas chromatography of TCE. The results obtained from each composite embodiment are illustrated in FIG. 10. As illustrated in FIG. 10, graphene supported Au—Pd alloy has significant catalytic efficiency, and in some embodiments, this particular composite exhibited higher reactivity than graphene supported Au—Pd having a heterostructure. As illustrated in FIG. 10, the TCE concentration decreased 50% after 10 seconds, and even longer time periods produced a more than 95% decrease in TCE concentration. TCE was substantially (such as completely) degraded after 5 minutes. Other embodiments of the disclosed composite, such as carbon black supported Au—Pd alloy, exhibited very efficient catalytic performance. In certain embodiments, the TCE concentration decreased to 13% (of pristine concentration) after 5 minutes, and after 10 minutes, more than 95% TCE was decomposed.

TNT Degradation Studies:

Some embodiments illustrate the ability of the disclosed composite to degrade TNT. The reaction of each composite with TNT was monitored through gas chromatography of TNT, with the results illustrated in FIG. 11. The graphene supported Au—Pd alloy composite illustrated fast TNT degradation kinetics. After 60 seconds, the TNT concentration decreased by 55% and 10 minutes was 100% degraded. There were many different peaks appearing in HPLC chromatogram at different sampling points, likely correlating to the formation of various intermediate products.

2-CAP Degradation Studies:

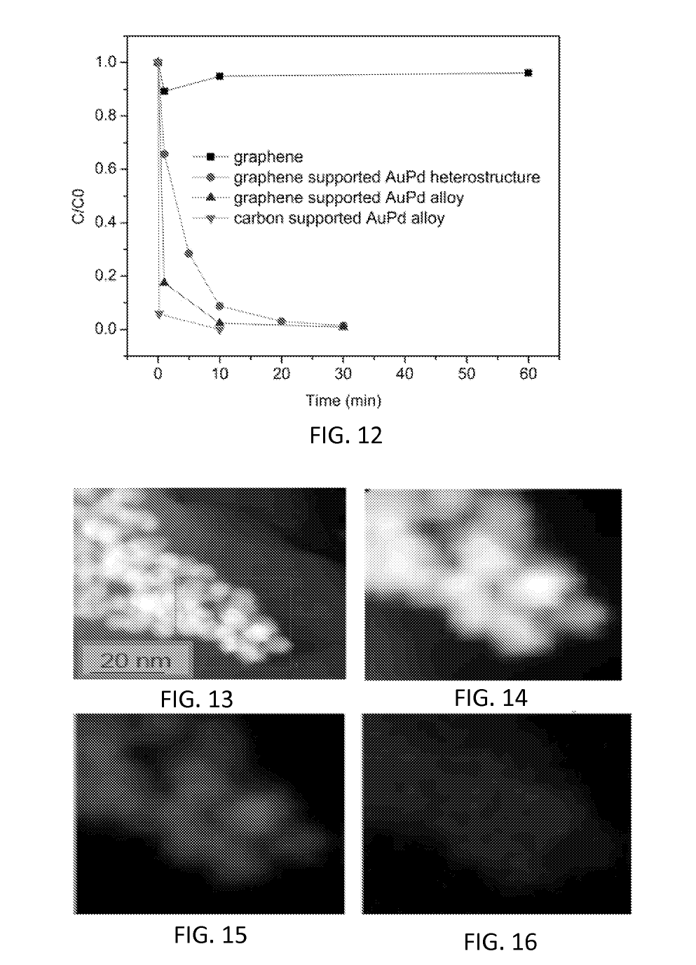

Some embodiments illustrate the ability of the disclosed composite to degrade 2-CAP. The reaction of each composite with 2-CAP was monitored through gas chromatography of 2-CAP, with the results illustrated in FIG. 12. Both the graphene supported Au—Pd heterostructure composite and the graphene supported Au—Pd alloy composite had fast 2-CAP removal, and in some embodiments, the alloy composite illustrated a slightly faster reaction rate. For the graphene supported Au—Pd alloy composite, more than 83.3% of 2-CAP was degraded in 1 minute, and then after 10 minutes, 98% 2-CAP was removed. The carbon black supported Au—Pd alloy composite illustrated fast degradation rates—more than 94.1% of 2-CAP was degraded in 1 minute, and then after 10 minutes, no 2-CAP was detected.

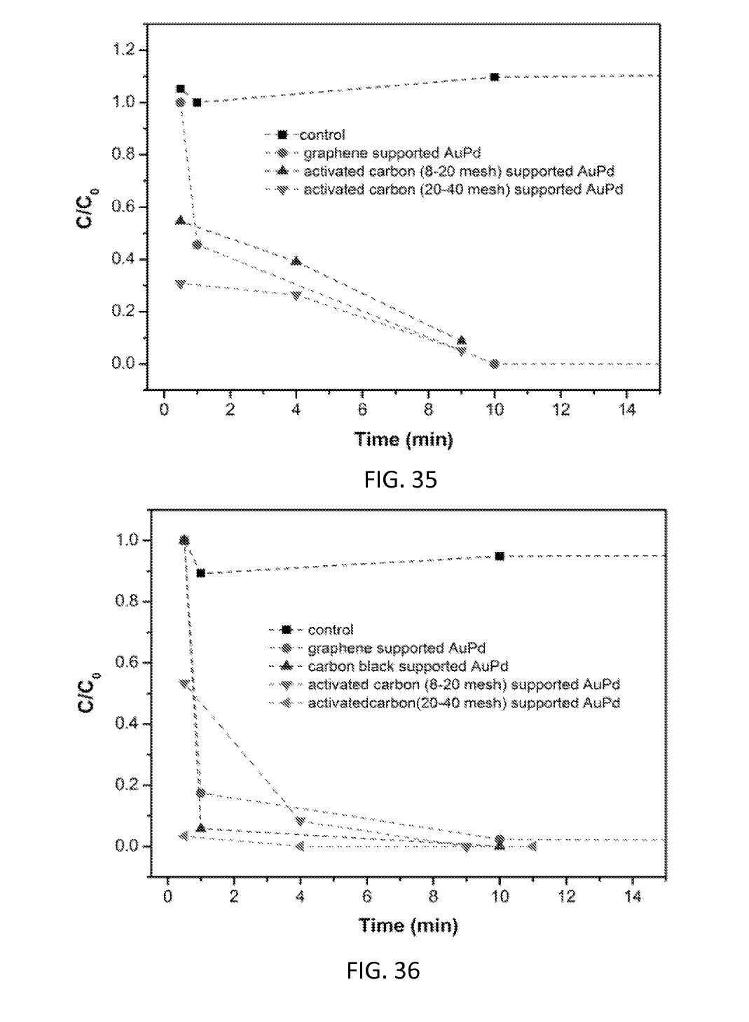

In an additional example, the ability of granular activated carbon supported Au—Pd alloys to act as efficient hydrodechlorination (HDC) catalysts for degrading TCE was determined. The reaction of the catalysts with TCE was monitored using headspace gas chromatography of TCE, as shown in FIG. 34. These results corroborate that granular activated carbon-supported Au—Pd alloy exhibits significant catalytic efficiency. Rates of TCE removal were very rapid, with 90% disappearance of the parent compound by the first time point (a few sconds) and no detectable TCE after ˜4 minutes. The comparatively minor loss of TCE from the control embodiments suggests that hydrodehalogenation (HDH) is the major process involved in the degradation of the TCE. In some embodiments, the granular activated carbon-supported Au—Pd alloy exhibited higher catalytic efficiency as compared to other alloy embodiments, such as graphene supported Au—Pd alloy and carbon black supported Au—Pd alloy. In particular disclosed embodiments, the activated carbon (8-20 mesh) supported AuPd and activated carbon (20-40 mesh) were able to dechlorinate and thereby remove 95% and 99.7% TCE in 30 seconds respectively. This data indicate that there can be a synergistic effect between physical absorption and chemical degradation and that activated carbon supported AuPd embodiments can exhibit surprising reactivity. Similar results also were obtained for degrading TNT (FIG. 35) and 2-CAP (FIG. 36). In this particular embodiment, the bi-metallic composite comprising fine (e.g., 20-40 mesh) GACs exhibited faster degradation than the coarse (e.g., 8-20 mesh) GACs, while both exhibited much faster TCE degradation than the embodiments used in this example (FIG. 34). Without being limited to a single theory of operation, it is currently believed that due to the higher surface to volume ratio of the fine mesh GACs, as compared to that of the coarse mesh size of GAC, the deposition of Au—Pd on the GAC of fine mesh size may result in more catalytic surface area than on the GAC of coarse mesh size. Other possible theory is that this reactivity may be attributed to localized concentration of catalytic sites affected by the pore sizes of the GAC, the molecular size of the probe contaminant, and/or H₂ in the GAC pores.

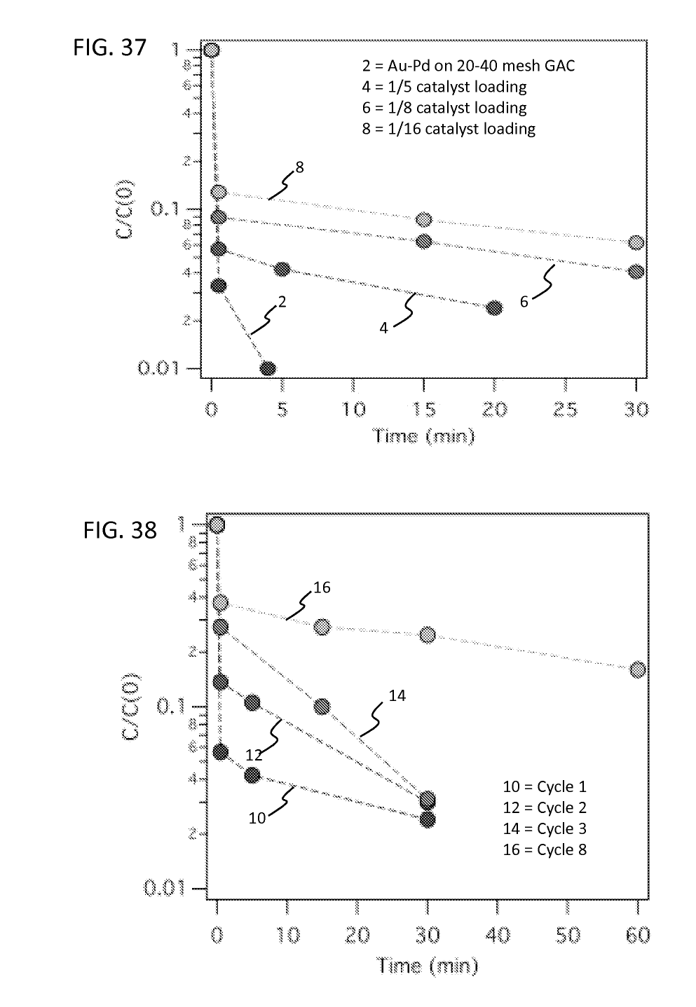

In another embodiment, the effect of Au—Pd loading density on composite performance was assessed. Catalysts having low concentrations of Pd and Au precursors were made, such as indicated above. Using the catalyst formulation presented in FIG. 34 as the control sample (Line 2 in FIG. 37), two concentration modifications were made using 1/5, 1/8, and 1/16 of the metal precursor concentrations (designated as “1/5 catalyst sample” [Line 4], “1/8 catalyst sample” [Line 6], and “1/16 catalyst sample” [Line 8], in FIGS. 37 and 38). As illustrated in FIG. 37, all three samples reduced TCE very rapidly; more than 90% of the TCE was degraded in a few seconds. While the control sample (Line “2”) completed the degradation within 4 minutes, it took ˜20 for the “1/5 catalyst sample” (Line “4”) and ˜30 minutes for the “1/8 catalyst sample” (Line “6”) and “1/16 catalyst sample” (Line “8”) to completely reduce HDH, respectively. The increased time for the degradation appears to be directly dependent on the amount of decreased organometallic precursors, suggesting that the methods of making disclosed herein fully utilizes the organometallic precursors to form Au—Pd nanoparticles. These results also suggest that if a very fast degradation rate (e.g., within a few minutes) is not required in a practical application, then moderate degradation rates could be achieved by loading the metallic precursors at a lower density on the support material, thereby providing an alternative way to make the disclosed composites more cost effective without sacrificing the ultimate effectiveness of the catalysts. To evaluate the stability of the catalysts, the “1/5 catalyst sample” was used in re-spike tests. In particular, TCE was added 8 times in 10 minute intervals and the disappearance of TCE was measured in each interval. The results (FIG. 38) indicate that TCE degradation was still rapid after the eighth re-spike (although the concentration of TCE after each refill was slightly higher than the previous one because of carry-over from the previous test). Nevertheless, these results indicate that the catalyst has considerable stability, even at low Au—Pd loading.

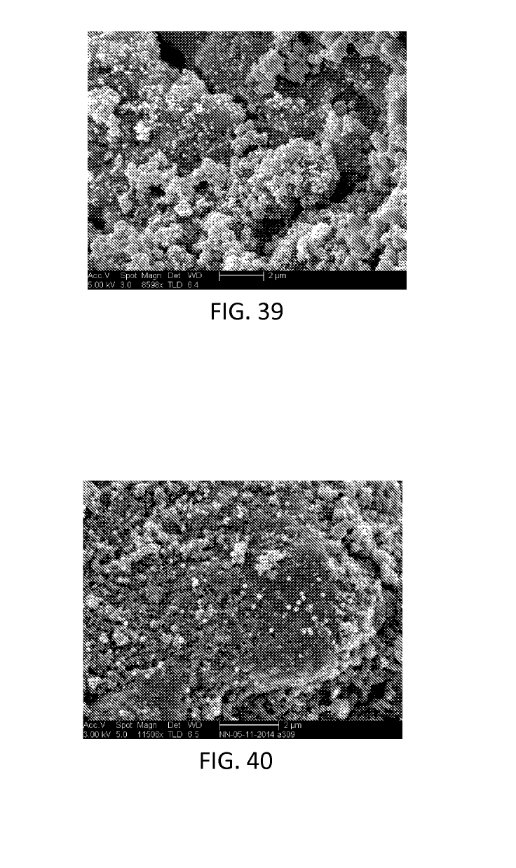

In yet another example, the stability of a granular activated carbon supported Au—Pd composite embodiment was examined. To test the recycling stability of the composite, the degradation curves of TCE using five cycles were obtained (FIG. 38). The results indicated that after five cycles, the composite can still decompose 90% of the initial TCE concentration after 30 minutes, corroborating that these composite embodiments are stable. In addition, an SEM technique was used to determine the difference of the attached AuPd composite before and after the five-cycles of TCE degradation. The results illustrated in FIGS. 39 and 40 indicate that there is no substantial difference between the composite before and after reaction, thereby indicating that the AuPd composite is well anchored on the surface of activated carbon and not easily disrupted.

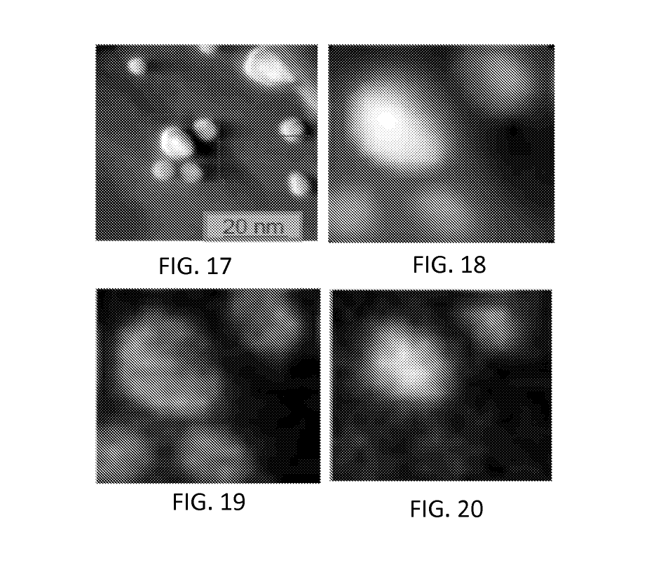

Structural Analysis: To investigate the crystalline structure of the heterostructured Au—Pd composite, a transmission electron microscope equipped with an energy dispersive X-ray spectrometer (EDS) was used for imaging and elemental mapping, respectively, which confirmed that the Pd nanocrystals form the core, with Au metal covering the Pd nanocrystals as an outer shell. These results are illustrated in FIGS. 17-20. The results illustrated in FIGS. 13-16 also confirm that for the Au—Pd alloy composite, both Pd and Au metals are completely and evenly distributed in the crystal, thus indicating that Au and Pd form the alloy composite.

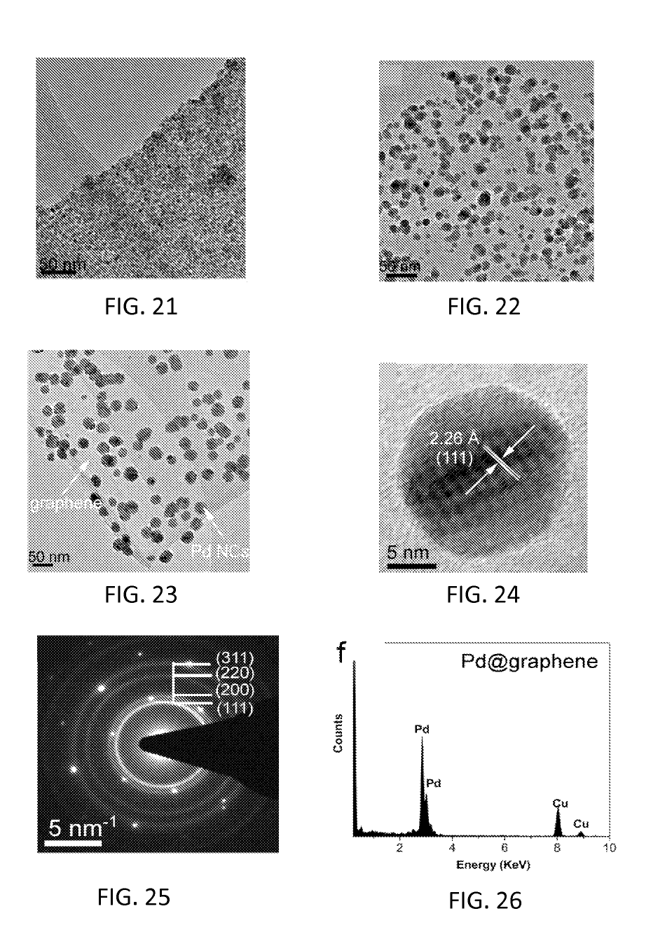

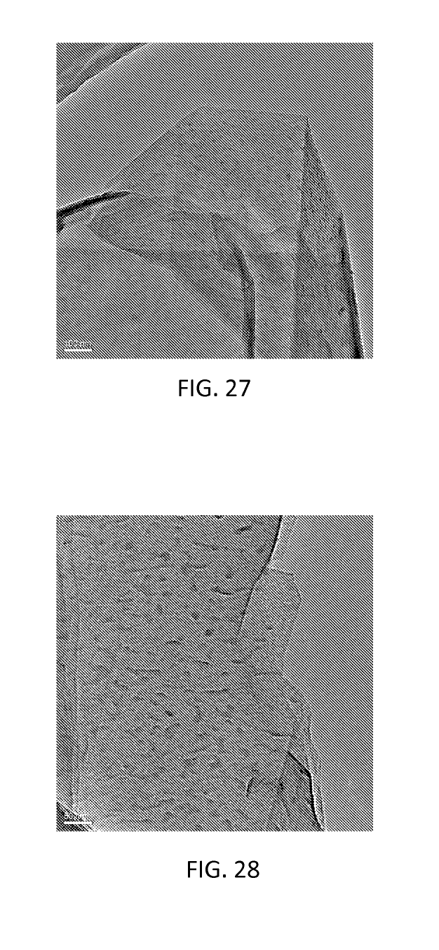

Additional embodiments concern analysis of graphene-Pd and graphene-Au hybrids. In one embodiment, Pd was deposited on a graphene support using a solvothermal reaction at 110° C. A variety of reaction times were used, such as 4 hours, 8 hours, and 12 hours. The Pd was deposited on the graphene in nanocrystalline form, as illustrated in FIGS. 21-26. In other embodiments, Au was deposited on graphene at room temperature. The Au was not deposited on the graphene in nanocrystalline form, as illustrated in FIGS. 27 and 28. These results corroborated the theory that, in some embodiments using Pd, Au, and graphene (such as to provide a heterostructured composite), the Pd should be combined first with the graphene and then the Au component should be added.

Computational Analysis:

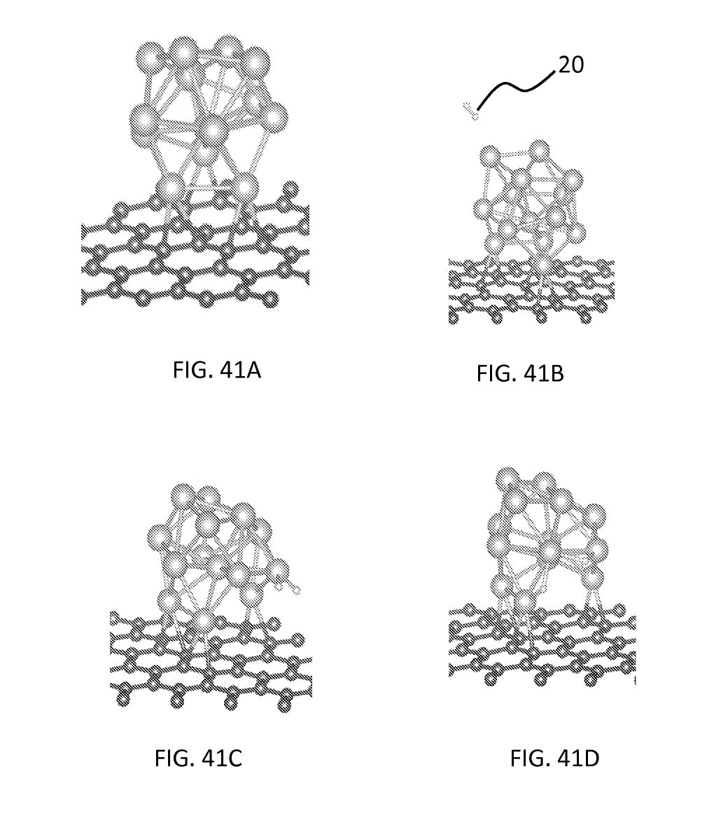

DFT calculations were performed on a simulated model system to demonstrate the ability to use numerical modeling of the composite structures. In this embodiment, the model system comprised a GAC substrate, which consists mainly of carbon (C) atoms, and Pd-based bimetal particles, which are primarily formed on the surface of the GACs. The surface of the GAC was approximated as a mixture of graphene and highly defective graphene where the Pd-based bimetal particles are located. Under this simulation condition, a sample model in which seven Pd and seven Au atoms were adsorbed on a single layer of graphene was calculated. The results are shown in FIGS. 41A-41D. The Pd atoms tend to connect to the graphene surface while Au atoms gather away from the surface. Also, six (out of seven) Pd atoms and seven Au atoms form a cluster, among which three Pd atoms bond to the C atoms of the graphene surface. One Pd atom, however, appears to act as a “core” located in the center supporting the shape of the Au—Pd cluster and Au atoms arrange around the Pd atoms to form the Au-capped Pd cluster.

To simulate dehydrogenation at different adsorption sites, the same model system illustrated in FIG. 41 was used as the initial sample configuration, wherein a (Au—Pd)₇ cluster was adsorbed on a 6×6 graphene supercell surface. An H₂ molecule (labeled as “20” in FIG. 41B) was placed near the cluster. When the H₂ molecule was located close to Au atoms, the change of the H—H bond length was negligable, and the binding energy between H₂ and the graphene supported (Au—Pd)₇ cluster was fairly low, indicating a physisorption (FIG. 41B). When the H₂ molecule was placed closer to Pd than to Au atoms, however, the H—H bond was broken and chemisorption occurred as shown in FIG. 41C and FIG. 41D, wherein the H₂ molecule was broken into two H atoms attached to the Pd atoms.

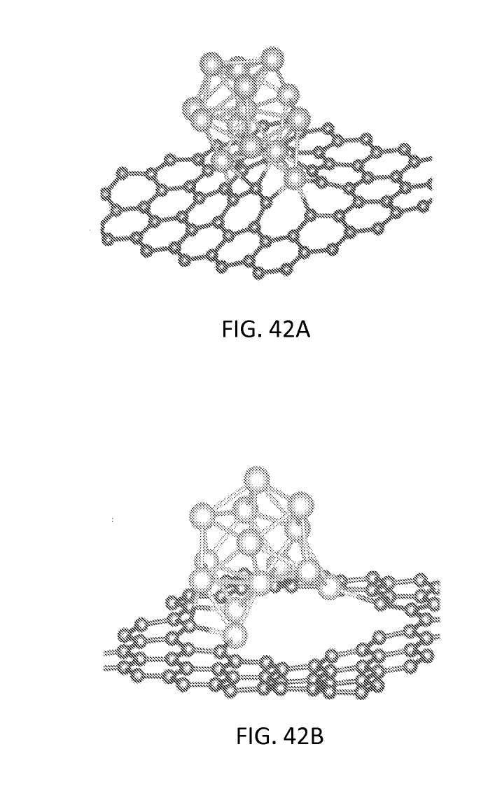

A defective graphene supported (Au—Pd)₇ cluster was also calculated to evaluate vacancy defects on the formation of the (Au—Pd)₇ cluster and their effect on the cluster's structural stability in view of the fact that some GAC surface area can be highly defective. The embodiments disclosed below can be used to determine different graphene defects, such as vacancy, interstitials, and Stone-Wales, as well as other defects found in carbon-containing materials, such as granular activated carbon. In FIG. 42A, it is illustrated that the (Au—Pd)₇ cluster retains its shape and bonds when it anchored on a slightly defective graphene surface. When the vacancy density of the defects is high, such as in FIG. 42B, the (Au—Pd)₇ cluster was deformed to allow more Pd atoms to be bonded to the C atoms of the surface. The “core” Pd atom in FIG. 42B tends to be exposed as a surface atom, which may indicate that the active surface area of Au—Pd clusters on the defective graphene surface will be higher than that of Au—Pd clusters on perfect graphene. These simulation results are consistent with the experimental results obtained by a preliminary comparison of the catalytic activities between GAC-supported Au—Pd and graphene-supported Au—Pd. For example, in some embodiments, the GAC-supported Au—Pd bimetal composite embodiments exhibited superior catalytic performance to the low defect density graphene-supported Au—Pd bimetals for TCE degradation. Accordingly, a systematic and in-depth numerical calculation using the proposed simulation models disclosed herein can provide guidance and validations for the embodiments of composites and methods of making such composites as disclosed herein. In some embodiments, the modeling embodiments disclosed herein also can be used to calculate the different bi-metallic compositions disclosed herein with respect to the adsorption or decomposition of different molecules and oxyanions, with some examples being H₂, O₂, HCl, H₂S, and NO₂⁻. These can be used to simulate the dehydrogenations and deoxygenations at different adsorption sites.

### VI. Overview of Several Embodiments

In some embodiments disclosed herein, a method is disclosed wherein the method comprises combining a first metallic precursor comprising a Group 8, Group 9, or a Group 10 metal, a second metallic precursor comprising a Group 11 or Group 13 metal, and a solid support material at a temperature substantially at or above room temperature to form a mixture; and isolating a composite material having a heterostructure or alloy structure from the mixture, wherein the mixture is free of surfactants or extraneous reducing agents. In some embodiments, the first metallic precursor and the second metallic precursor can be combined and maintained at a temperature ranging from about 19° C. to 110° C.

In some embodiments, the first metallic precursor comprises a metal selected from Ni, Pd, Pt, Ir, Rh, Ru, or combinations or ions thereof.

In any or all of the above embodiments, the first metallic precursor comprises Pd⁰, Pd⁺² or Pd⁺⁴.

In any or all of the above embodiments, the first metallic precursor is selected from Pd(OAc)₂, Pd(acac)₂, PdCl₂, Pd(dba)₂, Pd(OH)₂, Pd nanocrystals, Pd nanoparticles, or combinations thereof.

In any or all of the above embodiments, the second metallic precursor comprises a metal selected from Cu, Ag, Au, Al, In, or combinations or ions thereof.

In any or all of the above embodiments, the second metallic precursor comprises Au⁰, Au⁺² or Au⁺⁵.

In any or all of the above embodiments, the second metallic precursor is selected from HAuCl₄, Cu(NO₃)₂, AgNO₃, aluminum nanoparticles, or combinations thereof.

In any or all of the above embodiments, the solid support material is selected from graphene, graphite, carbon black, carbon fiber, carbon aerogel, carbon nanotubes, granular activated carbon, alumina, silica, zeolites, magnetite, or combinations thereof. In any or all of the above embodiments, the solid support is exfoliated graphene.

In any or all of the above embodiments, the solid support is granular activated carbon having a mesh size ranging from 8 to 40 mesh.

In any or all of the above embodiments, the first metallic precursor is provided at a concentration of 0.6 mg/mL to 1.2 mg/mL.

In any or all of the above embodiments, the second metallic precursor is provided at a concentration of 0.1 mg/mL to 1 mg/mL.

In any or all of the above embodiments, the first metallic precursor and the second metallic precursor are mixed with the solid support material substantially simultaneously. In some embodiments, the first metallic precursor and the second metallic precursor are mixed with the solid support material sequentially. In some embodiments, the first metallic precursor and the solid support material are combined and then mixed with the second metallic precursor. In some embodiments, the method further comprises heating the first metallic precursor and the solid support material prior to mixing with the second metallic precursor.

In some embodiments, the method is a method for making a bi-metallic composite having an alloy structure, wherein the method comprises combining a Pd⁺²-containing reagent with an Au⁺⁵-containing reagent and a solid support material selected from graphene, graphite, carbon fiber, carbon aerogel, carbon nanotubes, alumina, silica, zeolites, magnetite, granular activated carbon, or combinations thereof; and mixing the Pd⁺²-containing reagent, the Au⁺⁵-containing reagent, and the solid support material for a period of time effective to make the bi-metallic composite. In some embodiments, the method is a method for making a bi-metallic composite having a heterostructure, wherein the method comprises combining a Pd⁺²-containing reagent with a solid support material selected from graphene, graphite, carbon fiber, carbon black, carbon aerogel, carbon nanotubes, granular activated carbon, alumina, silica, zeolites, magnetite, or combinations thereof; heating the Pd⁺²-containing reagent and the solid support material to promote Pd metal deposition on the solid support material; and adding an Au⁺⁵-containing reagent to the Pd⁺²-containing reagent and the solid support material. In some embodiments, heating comprises heating at a temperature ranging from 80° C. to 200° C.

In some embodiments, a method is disclosed wherein the method consists of combining a first metallic precursor comprising a Group 8, Group 9, or a Group 10 element, a second metallic precursor comprising a Group 11 or Group 13 metal, and a solid support material at a temperature substantially at or above room temperature to form a mixture; and isolating a composite material having a heterostructure or alloy structure from the mixture, wherein the mixture is free of surfactants or extraneous reducing agents.

In some embodiments, the bi-metallic composite is a bi-metallic composite made according to any of the above methods.

In some embodiments, the bi-metallic composite comprises a first metal component selected from Pd, Pt, Rh, Ru, or Ni; a second metal component selected from Au, Ag, Al, In, or Cu; and a support material selected from graphene, graphite, carbon fiber, carbon aerogel, carbon nanotubes, granular activated carbon, alumina, silica, zeolites, magnetite, or combinations thereof.

In any or all of the above embodiments, the bi-metallic composite has a heterostructure structure.

In any or all of the above embodiments, the second metal component substantially coats the first metal component.

In any or all of the above embodiments, the second metal component partially coats the first metal component.

In some embodiments, the bi-metallic composite has an alloy structure.

In some embodiments, a method is disclosed that comprises exposing a contaminant to the composite according to any or all of the above embodiments.

In some embodiments, the contaminant is in a fluid.

In any or all of the above embodiments, the fluid is a liquid.

In any or all of the above embodiments, the contaminant comprises one or more carbon-hydrogen bonds, carbon-nitrogen bonds, carbon-carbon bonds, carbon-oxygen bonds, carbon-halide bonds, nitrogen-nitrogen bonds, or combinations thereof.

In any or all of the above embodiments, the contaminant is selected from a halogenated organic compound, a nitro-containing compound, an N-nitrosoamine, an oxyanion-containing compound, or combinations thereof.

In any or all of the above embodiments, the contaminant is selected from carbon tetrachloride, TCE, TPC, caffeine, microcystin, diatrizoate, 2-CAP, TNT, NDMA, acid orange 7, acid red 88, alcian yellow, alizarine yellow R, allura red AC, amaranth, amido black 10B, aniline yellow, azo violet, azorubine, biebrich scarlet, Bismarck brown R or Y, black 7984, brilliant black BN, brown FK, brown HT, chrysoine resorcinol, citrus red 2, congo red, Evans blue, fast yellow AB, hydroxynaphthol blue, methyl violet, methyl orange, methyl red, methyl yellow, sudan black, sudan I, II, III, or IV, sudan red, sudan yellow, tartrazine, trypan blue, methylene blue, nitrate, nitrite, perchlorate, or chlorate.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A method for making a heterostructured composite material or an alloy composite material, comprising: combining, in the absence of any surfactants, or extra reducing agent and at a temperature ranging from about 19° C. to 110° C., a first metallic precursor comprising a Group 8, Group 9, or a Group 10 element, a second metallic precursor comprising a Group 11 or Group 13 metal, and a solid support material, wherein the first metallic precursor and the solid support material are mixed together prior to addition of the second metallic precursor to form the heterostructured composite material, and wherein the solid support used to make the alloy composite material is selected from carbon black, carbon fiber, carbon aerogel, activated carbon, zeolites, magnetite, or a combination thereof.

2. The method of claim 1, wherein the temperature ranges from about 100° C. to 110° C.

3. The method of claim 1, wherein the temperature ranges from 19° C. to 25° C.

4. The method of claim 1, wherein the first metallic precursor comprises a metal selected from Ni, Pd, Jr, Rh, Ru, or combinations or ions thereof.

5. The method of claim 1, wherein the first metallic precursor comprises Pd⁰, Pd⁺² or Pd⁺⁴.

6. The method of claim 1, wherein the first metallic precursor is selected from Pd(OAc)₂, Pd(acac)₂, PdCl₂, Pd(dba)₂, Pd(OH)₂, Pd nanocrystals, Pd nanoparticles, or combinations thereof.

7. The method of claim 1, wherein the second metallic precursor comprises a metal selected from Cu, Ag, Au, Al, In, or combinations or ions thereof.

8. The method of claim 1, wherein the second metallic precursor comprises Au⁰, Au⁺² or Au⁺³.

9. The method of claim 1, wherein the second metallic precursor is selected from HAuCl₄, Cu(NO₃)₂, AgNO₃, aluminum nanoparticles, or combinations thereof.

10. The method of claim 1, wherein the solid support material used to make the heterostructured composite material is selected from graphene, graphite, carbon black, carbon fiber, carbon aerogel, carbon nanotubes, activated carbon, alumina, silica, zeolites, magnetite, or combinations thereof.

11. The method of claim 1, wherein the solid support used to make the heterostructured composite material is exfoliated graphene.

12. The method of claim 1, wherein the solid support is granular activated carbon having a mesh size ranging from 8 to 40 mesh.

13. The method of claim 1, wherein the first metallic precursor is provided at a concentration of 0.6 mg/mL to 1.2 mg/mL.

14. The method of claim 1, wherein the second metallic precursor is provided at a concentration of 0.1 mg/mL to 1 mg/mL.

15. The method of claim 1, wherein the first metallic precursor and the second metallic precursor are mixed with the solid support material substantially simultaneously to form the alloy composite material.

16-19. (canceled)

20. The method of claim 1, wherein the method is a method for making an alloy composite material and the method comprises:
combining a Pd⁺²-containing reagent with an Au⁺³-containing reagent and the solid support material; and
mixing the Pd⁺²-containing reagent, the Au⁺³-containing reagent, and the solid support material for a period of time effective to make the alloy composite material.

21. The method of claim 1, wherein the method is a method for making a heterostructured composite material and the method comprises:
combining a Pd⁺²-containing reagent with the solid support material, which is selected from graphene, graphite, carbon fiber, carbon black, carbon aerogel, carbon nanotubes, activated carbon, alumina, silica, zeolites, magnetite, or combinations thereof;
heating the Pd⁺²-containing reagent and the solid support material to promote Pd metal cluster deposition on the solid support material; and
adding an Au⁺³-containing reagent to the Pd⁺²-containing reagent and the solid support material.

22. The method of claim 21, wherein heating comprises heating at a temperature ranging from 80° C. to 200° C.

23. A method, consisting of:
combining, at a temperature ranging from 19° C. to 110° C., a first metallic precursor comprising a Group 8, Group 9, or a Group 10 element, a second metallic precursor comprising a Group 11 or Group 13 metal, and a solid support material to form a mixture; and
isolating a composite material having a heterostructure or alloy structure from the mixture, wherein the mixture is free of surfactants or extraneous reducing agents.

24. A heterostructure or alloy bi-metallic composite, comprising:
a first metal component selected from Pd, Pt, Rh, Ru, or Ni;
a second metal component selected from Au, Ag, Al, In, or Cu; and
a support material selected from graphene, graphite, carbon fiber, carbon aerogel, carbon nanotubes, alumina, silica, zeolites, magnetite, granular activated carbon, or combinations thereof.

25. The heterostructure bi-metallic composite of claim 24, wherein the second metal component substantially coats the first metal component.

26. (canceled)

27. The heterostructure bi-metallic composite of claim 24, wherein the second metal component partially coats the first metal component.

28. (canceled)

29. A method, comprising exposing a contaminant to the heterostructure or alloy bi-metallic composite of claim 24.

30. (canceled)

31. The method of claim 29, wherein the fluid is a liquid.

32. (canceled)

33. The method of claim 29, wherein the contaminant is selected from a halogenated organic compound, a nitro-containing compound, an N-nitrosoamine, an oxyanion-containing compound, or combinations thereof.

34. The method of claim 29, wherein the contaminant is selected from carbon tetrachloride, TCE, TPC, caffeine, microcystin, diatrizoate, 2-CAP, TNT, NDMA, acid orange 7, acid red 88, alcian yellow, alizarine yellow R, allura red AC, amaranth, amido black 10B, aniline yellow, azo violet, azorubine, biebrich scarlet, Bismarck brown R or Y, black 7984, brilliant black BN, brown FK, brown HT, chrysoine resorcinol, citrus red 2, congo red, Evans blue, fast yellow AB, hydroxynaphthol blue, methyl violet, methyl orange, methyl red, methyl yellow, sudan black, sudan I, II, III, or IV, sudan red, sudan yellow, tartrazine, trypan blue, methylene blue, nitrate, nitrite, perchlorate, or chlorate.
